(19) United States
(12) Patent Application Publication
(10) Pub. No.: US 2025/0178003 A1
(43) Pub. Date: Jun. 5, 2025

(54) SHOWERHEAD

(71) Applicant: SINYU TECHNOLOGY (FUJIAN) CO., LTD., Zhangzhou (CN)

(72) Inventor: Zhangjun YU, Zhangzhou (CN)

(73) Assignee: SINYU TECHNOLOGY (FUJIAN) CO., LTD., Zhangzhou (CN)

(21) Appl. No.: 18/583,906

(22) Filed: Feb. 22, 2024

(30) Foreign Application Priority Data
Nov. 30, 2023 (CN) 202311638667X

(51) Int. Cl. B05B 1/16; B05B 1/18; E03C 1/04

(52) U.S. Cl. CPC B05B 1/1636; B05B 1/18; E03C 1/0409

(57) ABSTRACT

Showerhead includes casing, water inlet connector, water outlet assembly, switching assembly, and actuating component. The casing includes handle part and mounting part connected to each other; water inlet connector is mounted inside handle part; water outlet assembly is mounted on mounting part and includes water outlet body, rear cover, and water distribution plate. Water outlet body is provided with multiple independent flowing water channels, and water distribution plate is rotatably arranged on water outlet body; switching assembly is arranged inside casing and includes driving component, elastic component, and ratchet wheel; actuating component includes connecting rod, slide block, and switch; and switch is able to, under action of external force, actuate slide block to drive connecting rod to move in forward direction; connecting rod drives driving component to rotate at preset angle and, through first ratchet tooth, drives ratchet wheel, along with water distribution plate, to rotate at preset angle.

### CROSS-REFERENCE TO RELATED APPLICATIONS

This application claims the priority under 35 U.S.C. 119 to Chinese Patent Application No. 202311638667X, filed Nov. 30, 2023; the disclosure of which is incorporated herein by reference in its entirety.

### TECHNICAL FIELD

The present disclosure relates to the technical field of showerheads, and in particular to a showerhead.

### BACKGROUND ART

In common showerheads, the functions are usually arranged on the front surface of the showerhead panel. After switching, to return to the original setting, it needs to switch back from a distal end. For multifunctional showerheads, the switching distance is often too far, making it impossible to achieve one-handed control for switching the showerhead. This results in inconvenience in usage.

### SUMMARY

The present disclosure provides a showerhead comprising:
a casing, comprising a handle part and a mounting part that are connected to each other;
a water inlet connector, mounted inside the handle part;
a water outlet assembly, mounted on the mounting part and comprising a water outlet body, a rear cover, and a water distribution plate, wherein the water outlet body is provided with multiple independent flowing water channels, and the water distribution plate is rotatably arranged on the water outlet body;
a switching assembly, arranged inside the casing and comprising a driving component, an elastic component, and a ratchet wheel,
   wherein the ratchet wheel is connected to the water distribution plate, and the driving component is rotatably connected to the rear cover and is configured to drive the ratchet wheel to drive the water distribution plate to rotate; the driving component is provided with a first ratchet tooth engaged with the ratchet wheel; one end of the elastic component is connected to the driving component; and the other end of the elastic component is connected to the water outlet body, and is configured to pull the driving component to reset via the elastic component; and
an actuating component, comprising a connecting rod, a slide block, and a switch,
   wherein the switch is connected to the slide block, and the slide block is slidingly connected to the water inlet connector; one end of the connecting rod is connected to the slide block, and the other end of the connecting rod is hinged to the driving component, and is configured to drive the driving component to rotate through the connecting rod;
   the switch is able to, under the action of external force, actuate the slide block to drive the connecting rod to move in a forward direction; the connecting rod drives the driving component to rotate at a preset angle and, through the first ratchet tooth, drives the ratchet wheel, along with the water distribution plate, to rotate at the preset angle; and
   when the external force applied to the switch is removed, the elastic component pulls the driving component to rotate back and drives the connecting rod to move in a reverse direction; by arranging a second ratchet tooth on the rear cover to abut against the ratchet wheel, positions of the ratchet wheel and the water distribution plate are limited; and the connecting rod drives the slide block and the switch to reset, thus achieving the switching of the function of water spray.

### BRIEF DESCRIPTION OF DRAWINGS

In order to more clearly illustrate the technical solutions of the embodiments of the present disclosure, the following will briefly introduce the drawings used in the embodiments. It should be understood that the following drawings only show some embodiments of the present disclosure, and therefore it should not be regarded as a limitation on the scope. Those ordinary skilled in the art can also obtain other related drawings based on these drawings without inventive effort.

FIG. 1 shows a schematic structural diagram of a view of a showerhead provided by some embodiments of the present disclosure;

FIG. 2 shows an exploded view of a showerhead provided by some embodiments of the present disclosure;

FIG. 3 shows a schematic structural diagram of a view of an internal structure of the showerhead provided by some embodiments of the present disclosure;

FIG. 4 shows a schematic structural diagram of a view of a connecting rod connected to a slide block in a showerhead provided by some embodiments of the present disclosure;

FIG. 5 shows a schematic structural diagram of a view of a rear cover of the showerhead provided by some embodiments of the present disclosure;

FIG. 6 shows a schematic structural diagram of a view of a driving component of the showerhead provided by some embodiments of the present disclosure;

FIG. 7 shows a schematic structural diagram of a view of a water distribution plate of the showerhead provided by some embodiments of the present disclosure;

FIG. 8 shows a schematic structural diagram of a view of a ratchet wheel of the showerhead provided by some embodiments of the present disclosure; and

FIG. 9 shows a schematic structural diagram of a view of a water inlet connector of the showerhead provided by some embodiments of the present disclosure.

### REFERENCE NUMERALS

100—casing; 110—handle part; 111—strip-shaped hole; 120—mounting part; 200—water inlet connector; 210—slide rail; 300—water outlet assembly; 310—water outlet body; 320—rear cover; 321—flange; 322—protrusion; 330—water distribution plate; 331—water distribution hole; 332—limiting column; 340—second ratchet tooth; 400—switching assembly; 410—driving component; 411—first guide hole; 412—through-hole; 413—guide groove; 420—elastic component; 430—ratchet wheel; 440—first ratchet tooth; 500—actuating component; 510—connecting rod; 511—first connecting rod; 512—first guide rod; 512a—limit hole; 513—second cylindrical body; 520—slide block; 521—second guide hole; 530—switch; 600—connecting part; 700—limiting base; 710—boss.

### DETAILED DESCRIPTION

The following is a detailed description of the embodiments of the present disclosure, with examples shown in the drawings. Throughout the description, similar or identical reference numerals indicate corresponding or similar elements with the same or similar functions. The embodiments described below by reference to the drawings are exemplary and are intended only to explain the present disclosure and are not to be construed as a limitation of the present disclosure.

It should be clarified that when an element is described as being “fixed” to another element, it can be directly attached to the other element, or there can be an intermediary element. When an element is said to be “connected” to another element, it could be directly attached to the other element or may have an intermediary element. Conversely, when an element is described as being “directly on” another element, there is no intermediary element. The terms used herein, such as “vertical”, “horizontal”, “left”, “right”, and similar expressions, are used for explanatory purposes.

In the present disclosure, unless otherwise clearly stipulated and limited, the terms “provide”, “link”, “connect” and “fix” should be understood in a broad sense, for example, it can be a fixed connection, a detachable connection, or an integral connection, it can be a mechanical connection, an electrical connection, a direct connection, an indirect connection through an intermediary, an internal communication between two components, or the interaction relationship between two components. Those of ordinary skill in the art can understand the meanings of the above terms in the present disclosure according to specific situations.

Additionally, the terms “first” and “second” are used for descriptive objectives only and should not be understood as indicating or implying relative importance or specifying the quantity of the indicated technical features. Consequently, features labeled with “first” or “second” can explicitly or implicitly include one or more of those features. In the description of the present disclosure, the term “multiple” means two or more, unless otherwise explicitly specified.

Unless otherwise defined, all technical and scientific terms used herein have the same meaning as commonly understood by one of ordinary skill in the technical field of the present disclosure. The terms used herein in the description of the present disclosure are for the purpose of describing specific embodiments only and are not intended to limit the present disclosure. The term “or/and” as used herein includes any and all combinations of one or more related listed items.

The present disclosure provides a showerhead comprising:
a casing, comprising a handle part and a mounting part that are connected to each other;
a water inlet connector, mounted inside the handle part;
a water outlet assembly, mounted on the mounting part and comprising a water outlet body, a rear cover, and a water distribution plate, wherein the water outlet body is provided with multiple independent flowing water channels, and the water distribution plate is rotatably arranged on the water outlet body;
a switching assembly, arranged inside the casing and comprising a driving component, an elastic component, and a ratchet wheel,
   wherein the ratchet wheel is connected to the water distribution plate, and the driving component is rotatably connected to the rear cover, and is configured to drive the ratchet wheel to drive the water distribution plate to rotate; the driving component is provided with a first ratchet tooth engaged with the ratchet wheel; one end of the elastic component is connected to the driving component; and the other end of the elastic component is connected to the water outlet body, and is configured to pull the driving component to reset via the elastic component; and
   an actuating component, comprising a connecting rod, a slide block, and a switch,
      wherein the switch is connected to the slide block, and the slide block is slidingly connected to the water inlet connector; one end of the connecting rod is connected to the slide block, and the other end of the connecting rod is hinged to the driving component, and is configured to drive the driving component to rotate through the connecting rod;
      the switch is able to, under the action of external force, actuate the slide block to drive the connecting rod to move in a forward direction; the connecting rod drives the driving component to rotate at a preset angle and, through the first ratchet tooth, drives the ratchet wheel, along with the water distribution plate, to rotate at the preset angle; and
      when the external force applied to the switch is removed, the elastic component pulls the driving component to rotate back and drives the connecting rod to move in a reverse direction; by arranging a second ratchet tooth on the rear cover to abut against the ratchet wheel, positions of the ratchet wheel and the water distribution plate are limited; and the connecting rod drives the slide block and the switch to reset, thus achieving the switching of the function of water spray.

According to some embodiments of the present disclosure, one end of the rear cover facing towards the handle part is in communication with the water inlet connector, and one end of the rear cover facing towards the water outlet body is in communication with the water outlet body through the water distribution plate; and
the second ratchet tooth is arranged on a side of the rear cover facing toward the ratchet wheel, and the second ratchet tooth engages with the ratchet wheel to restrict the reverse rotation of the ratchet wheel.

According to some embodiments of the present disclosure, one end of the connecting rod close to the ratchet tooth is provided with a connecting part, and the connecting part is movably connected to the driving component.

According to some embodiments of the present disclosure, one side of the handle part is provided with a strip-shaped hole, and the strip-shaped hole is arranged along a length direction of the casing;
a part of the switch is exposed in the strip-shaped hole; and
the switch is slidably connected to the strip-shaped hole; one part of the switch is located on the outside of the handle part, and another part of the switch is located inside the handle part and connected to the slide block.

According to some embodiments of the present disclosure, the connecting rod comprises a first connecting rod and a first guide rod;
the connecting part is arranged at the end of the first guide rod near the driving component; an end of the first guide rod away from the driving component is provided with a second cylindrical body; and
one end of the first connecting rod is connected to the slide block, and the other end of the first connecting rod is connected to the second cylindrical body.

According to some embodiments of the present disclosure, along the length direction of the first guide rod, the first guide rod is provided with a limit hole; and
a side of the water outlet body facing the driving component is provided with a limiting base; and the limiting base is provided with a boss, wherein the boss passes through the limit hole to limit and guide the first guide rod through the boss.

According to some embodiments of the present disclosure, the driving component is rotationally provided between the rear cover and the ratchet wheel.

According to some embodiments of the present disclosure, a side of the rear cover facing the driving component is provided with a flange. The driving component is provided with a through-hole, and the driving component is rotatably sleeved on the flange through the through-hole.

The peripheral wall of the flange is provided with a protrusion. The driving component is provided with a guide groove, wherein the guide groove is in communication with the through-hole. The protrusion is embedded in the guide groove to limit the rotation angle of the driving component.

According to some embodiments of the present disclosure, the inner wall of the through-hole fits against the outer wall of the flange, and an axis of the flange coincides with an axis of the through-hole.

According to some embodiments of the present disclosure, the flange is annular in shape, and a pivot of the water distribution plate can pass through an inner ring of the flange to snap with the ratchet wheel.

According to some embodiments of the present disclosure, a side of the slide block facing the water inlet connector is provided with a second guide hole, and a side of the water inlet connector facing the slide block is provided with a slide rail.

The slide rail is movably arranged in the second guide hole,
and the slide block is slidably connected to the water inlet connector through the second guide hole.

According to some embodiments of the present disclosure, a side of the water inlet connector facing the slide block is provided with a slide rail, wherein the slide rail extends along a length direction of the water inlet connector.

According to some embodiments of the present disclosure, the switch is capable of, under the action of external force, driving the slide block to slide in the forward direction along the length direction of the water inlet connector and driving, by the slide block, the connecting rod to move in the forward direction.

According to some embodiments of the present disclosure, a limiting column is provided on the side of the water distribution plate facing toward the ratchet wheel. An axis of the limiting column coincides with an axis of the water distribution plate, and the limiting column is perpendicular to the water distribution plate.

According to some embodiments of the present disclosure, one end of the water distribution plate passes through the rear cover and the driving component, and the water distribution plate is connected to the ratchet wheel.

According to some embodiments of the present disclosure, the preset angle is a positive integer multiple of the central angle corresponding to one ratchet tooth of the ratchet wheel.

The embodiments of the present disclosure have the following beneficial effects. The user pulls the switch and then the switch is able to drive the driving component to rotate through the connecting rod. The rotation of the driving component, in turn, drives the water distribution plate to rotate in the forward direction through the ratchet wheel, thus achieving the switching in the position of the water distribution plate. After the external force acting on the switch is withdrawn, the elastic component, under the force of elasticity, pulls the driving component to rotate back so that the driving component, connecting rod, and locking mechanism are enabled to reset. This not only reduces the difficulty of switching the position of the water distribution plate but also enhances the efficiency, continuity, and accuracy of the switching process for the position of the water distribution plate. Additionally, since the ratchet wheel is provided with multiple consecutive ratchet teeth, users can achieve the switching of multiple positions of the water distribution plate with one hand, thereby improving the diversity, efficiency, and convenience of the switching process. The showerhead provided in the present disclosure not only enhances the diversity of water spray modes of the showerhead but also improves the efficiency of adjusting different water spray modes of the showerhead, thereby enhancing the overall experience of the user.

To make the above objectives, features, and advantages of the present disclosure more evident and comprehensible, the following preferred embodiments are described in detail with the drawings.

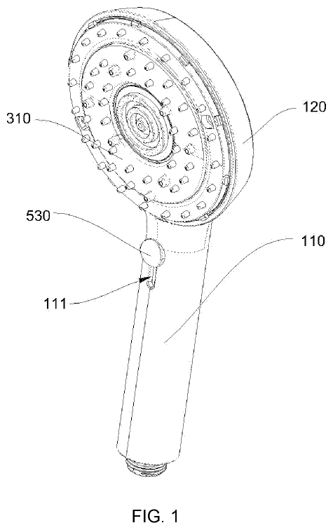

As shown in FIGS. 1 to 4, some embodiments of the present disclosure provide a showerhead, which is mainly applied to the showerheads to enhance the diversity of water spray modes of the showerhead and improve the stability and adjustment efficiency of the water spray modes of the showerhead.

The showerhead includes a casing 100, a water inlet connector 200, a water outlet assembly 300, a switching assembly 400, and an actuating component 500.

The casing 100 includes a handle part 110 and a mounting part 120 that are connected to each other. Additionally, the connection method between the handle part 110 and the mounting part 120 includes threaded connection, bolt connection, snap-fit, adhesive bonding, magnetic coupling, or integral molding, one of which depends on the specific requirements.

In the embodiment, the casing 100 formed by integrating the handle part 110 and the mounting part 120 enhances the stability, overall strength, and durability of the casing 100.

Additionally, the water inlet connector 200 is mounted inside the handle part 110, one end of the water inlet connector 200 is configured to connect with an external water source, and the other end of the water inlet connector 200 is connected to the water outlet assembly 300 so as to allow the external water to enter the water outlet assembly 300 through the water inlet connector 200 and be discharged through the water outlet assembly 300.

The water outlet assembly 300 is mounted on the mounting part 120. The water outlet assembly 300 includes a water outlet body 310, a rear cover 320, and a water distribution plate 330, wherein the water distribution plate 330 is provided between the water outlet body 310 and the rear cover 320. The water outlet body 310 is provided with multiple independent flowing water channels, that is, the water outlet body 310 has a plurality of different water spray functions. The water distribution plate 330 is rotatably arranged on the water outlet body 310. This allows for the adjustment of the water spray function of the water outlet body 310 through the water distribution plate 330 during the process of the water distribution plate 330 rotating relative to the water outlet body 310.

The switching assembly 400 is arranged inside the casing 100 and the switching assembly 400 includes a driving component 410, an elastic component 420, and a ratchet wheel 430.

The ratchet 430 is connected to the water distribution plate 330. It is noteworthy that, in the embodiment, the ratchet wheel 430 is fixedly connected to the water distribution plate 330 so as to enable the ratchet wheel 430 to drive the water distribution plate 330 to rotate synchronously during the rotation process.

Moreover, the driving component 410 is rotatably connected to the rear cover 320, meaning that the driving component 410 can rotate relative to the rear cover 320. This is used to drive the ratchet wheel 430 to drive the water distribution plate 330 to rotate during the rotation of the driving component 410 relative to the rear cover 320.

It should be noted that the driving component 410 is arranged on the side of the rear cover 320 away from the water outlet body 310, and the driving component 410 is provided with a first ratchet tooth 440 that engages with the ratchet wheel 430. Specifically, the first ratchet tooth 440 is arranged on the side of the driving component 410 facing the ratchet wheel 430, and the first ratchet tooth 440 engages with the ratchet wheel 430.

One end of the elastic component 420 is connected to the driving component 410; and the other end of the elastic component 420 is connected to the water outlet body 310 and is configured to pull the driving component 410 to reset via the clastic component 420. Specifically, when the driving component 410, under the tension of the actuating component 500, drives the ratchet wheel 430 to rotate by a certain angle, the clastic component 420 is in a stretched state, storing clastic potential energy. When the external force acting on the actuating component 500 disappears, the clastic component 420 tends to return to its original length under the action of the elastic potential energy. In other words, the elastic component 420 exerts tension on the driving component 410, causing the driving component 410 to reset under the tension of the elastic component 420.

It should be noted that the term “reset” here refers to the driving component 410 returning to its initial position under the elastic force of the elastic component 420. In this initial position, the first ratchet tooth 440 on the driving component 410 engages with the ratchet wheel 430.

The actuating component 500 includes a connecting rod 510, a slide block 520, and a switch 530.

The switch 530 is connected to the slide block 520, and along the length direction of the water inlet connector 200, the slide block 520 is slidably connected to the water inlet connector 200. It can be understood that the slide block 520 can slide relative to the water inlet connector 200 along the length direction of the water inlet connector 200.

Moreover, one end of the connecting rod 510 is connected to the slide block 520, meaning that the connecting rod 510 moves synchronously with the slide block 520. The other end of the connecting rod 510 is hinged to the driving component 410, meaning that the connecting rod 510 is rotationally connected to the driving component 410, and is configured to drive the driving component 410 to rotate through the connecting rod 510. It can be understood that, during the movement of the connecting rod 510 along the length direction of the water inlet connector 200, the connecting rod 510 can drive the driving component 410 to rotate.

In the embodiment, the switch 530 can, under the action of external force, drive the slide block 520 to slide in a forward direction along the length direction of the water inlet connector 200, and drive the connecting rod 510 to move in the forward direction through the slide block 520. As the connecting rod 510 moves in the forward direction, the connecting rod 510 drives the driving component 410 to rotate by a preset angle and, through the first ratchet tooth 440, drives the ratchet wheel 430 to rotate by a preset angle. Since the ratchet wheel 430 is connected to the water distribution plate 330, the water distribution plate 330 is synchronously rotated by the preset angle through the ratchet wheel 430. At the same time, during the rotation of the driving component 410, the elastic component 420 is stretched, and the clastic component 420 stores the elastic potential energy. At this point, the elastic component 420 tends to return to its original length under the influence of the elastic potential energy. In other words, at this point, the elastic component 420 exerts tension on the driving component 410.

It is important to note that in the embodiment, the preset angle is a positive integer multiple of the central angle corresponding to one ratchet tooth of the ratchet wheel 430. In other words, the preset angle can be the sum of the central angles corresponding to two or more ratchet teeth in the ratchet wheel 430.

Additionally, forward movement refers to the switch 530 moving along the length direction of the water inlet connector 200 in the direction away from the water outlet body 310.

When the external force acting on the switch 530 is withdrawn, at this point, the clastic component 420 remains in an extended state and exerts tension on the driving component 410. In other words, the elastic component 420 tends to return to its original length, thus causing the elastic component 420 to pull the driving component 410 to rotate back under the action of the elastic force. Simultaneously, the connecting rod 510 is driven to move in the reverse direction by the rotation of the driving component 410.

It is important to note that reverse movement refers to the connecting rod 510 moving along the length direction of the water inlet connector 200 in the direction close to the water outlet body 310.

At the same time, during the return rotation of the driving component 410, the second ratchet tooth 340, arranged on the rear cover 320, abuts against the ratchet wheel 430 so as to limit the ratchet wheel 430 and the water distribution plate 330 through the second ratchet tooth 340. This prevents the ratchet wheel 430 from rotating with the driving component 410, thus ensuring the stability of the ratchet wheel 430 and the water distribution plate 330. In other words, the ratchet wheel 430 and the water distribution plate 330 maintain their current state.

Specifically, as the connecting rod 510 moves in the reverse direction, it drives the slide block 520 and the switch 530 to move synchronously in the reverse direction. When the driving component 410 resets, the slide block 520 and the switch 530 reset synchronously, thereby switching the water spray function. In other words, at this point, the water distribution hole 331 on the water distribution plate 330 is in communication with one of the flowing water channels of the water outlet body 310, and the other flowing water channels of the water outlet body 310 are closed. It can be understood that when the driving component 410 rotates in the forward direction by the preset angle, the water inlet connector 200 selectively communicates to any one of the flowing water channels.

In the embodiment, one end of the water distribution plate 330 passes through the rear cover 320 and the driving component 410, and the water distribution plate 330 is connected to the ratchet wheel 430. It should be noted that a pivot is arranged on one side of the water distribution plate 330 in the thickness direction, wherein the pivot passes through the rear cover 320 and the driving component 410, and an axis of the pivot coincides with an axis of the water distribution plate 330. In the embodiment, one end of the water distribution plate 330 (referring to one end of the pivot) is snapped to the ratchet wheel 430. In other words, the water distribution plate 330 is fixedly connected to the ratchet wheel 430, which means that the water distribution plate 330 and the ratchet 430 rotate synchronously. The rotation is driven by the driving component 410, causing both the ratchet wheel 430 and the water distribution plate 330 to rotate in synchronization.

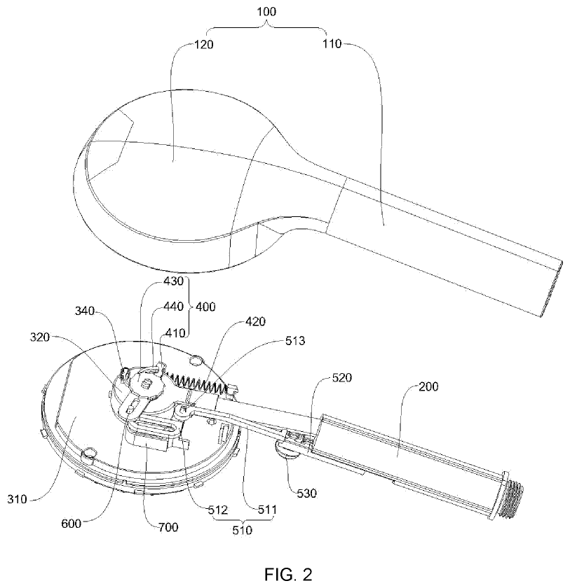

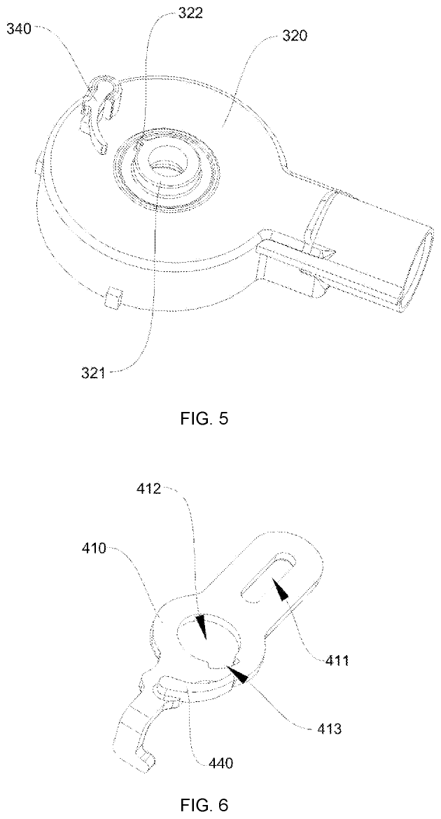

As shown in FIGS. 2 and 5, according to some embodiments of the present disclosure, one end of the rear cover 320 facing towards the handle part 110 is in communication with the water inlet connector 200, and one end of the water inlet connector 200 is configured to communicate with an external water source.

In addition, one end of the rear cover 320 facing towards the water outlet body 310 is in communication with the water outlet body 310 through the water distribution plate 330. Therefore, when the water in the water inlet connector 200 enters the rear cover 320, the water distribution plate 330 adjusts the water spray mode of the water outlet body 310, namely the switching of the water spray function of the showerhead.

Specifically, the second ratchet tooth 340 is arranged on a side of the rear cover 320 facing towards the ratchet wheel 430, and the second ratchet tooth 340 engages with the ratchet wheel 430, and is configured to restrict the reverse rotation of the ratchet wheel 430 by the second ratchet tooth 340 so as to ensure the stability of switching the water spray function.

As shown in FIGS. 2, 3, and 6, according to some embodiments of the present disclosure, one end of the connecting rod 510 close to the ratchet tooth is provided with a connecting part 600, and the connecting part 600 is movably connected to the driving component 410.

Specifically, the rotational axis of the driving component 410 is aligned with the rotational axis of the ratchet 430 so that the driving component 410 is capable of driving the ratchet wheel 430 to rotate coaxially during forward rotation.

The driving component 410 is provided with a first guide hole 411, and the first guide hole 411 extends along the length direction of the driving component 410. The length direction of the driving component 410 is perpendicular to the rotational axis.

One end of the connecting rod 510 close to the ratchet tooth is provided with a connecting part 600, and the connecting part 600 is movably arranged in the first guide hole 411. That is, one end of the connecting part 600 close to the driving component 410 is inserted into the first guide hole 411 and the connecting part 600 is slidably connected to the first guide hole 411. This allows the connecting rod 510 to drive the driving component 410 to move in the forward or reverse direction through the connecting part 600 during forward or reverse movement.

As shown in FIG. 1, according to some embodiments of the present disclosure, one side of the handle part 110 is provided with a strip-shaped hole 111, and the strip-shaped hole 111 is arranged along a length direction of the casing 100.

A part of the switch 530 is exposed through the strip-shaped hole 111, which means that a portion of the switch 530 is located on the outside of the handle part 110 so as to allow users to touch and adjust the position of the switch 530.

In addition, the switch 530 is slidably connected to the strip-shaped hole 111; and one part of the switch 530 is located on the outside of the handle part 110, and another part of the switch 530 is located inside the handle part 110 and connected to the slide block 520. It can be understood that when the user pulls the switch 530, the switch 530 moves along the strip-shaped hole 111 in the direction away from the mounting part 120. The hole wall of the strip-shaped hole 111 limits the movement distance of the switch 530 so as to enable the user to accurately control the movement position of the switch 530 during the process of pulling the switch 530. This improves the efficiency of switching the water spray function of the showerhead and enhances the user experience.

As shown in FIGS. 2 and 4, according to some embodiments of the present disclosure, the connecting rod 510 comprises a first connecting rod 511 and a first guide rod 512.

The connecting part 600 is arranged at the end of the first guide rod 512 near the driving component 410. The axis of the connecting part 600 is parallel to the axis of the ratchet wheel 430. An end of the first guide rod 512 away from the driving component 410 is provided with a second cylindrical body 513. The axis of the connecting part 600 is parallel to the axis of the second cylindrical body 513.

In addition, one end of the first connecting rod 511 is connected to the slide block 520, and the other end of the first connecting rod 511 is connected to the second cylindrical body 513. The first connecting rod 511 and the first guide rod 512 are connected through the second cylindrical body 513 so as to enable the synchronous movement of the first connecting rod 511 and the first guide rod 512.

Furthermore, along the length direction of the first guide rod 512, the first guide rod 512 is provided with a limit hole 512a, which means that the limit hole 512a is arranged along the length direction of the first guide rod 512.

In the embodiment, a side of the water outlet body 310 facing the driving component 410 is provided with a limiting base 700; the limiting base 700 is provided with a boss 710, wherein the boss 710 passes through the limit hole 512a to limit and guide the first guide rod 512 through the boss 710. This enhances the stability and smoothness of the movement of the first guide rod 512 and, at the same time, improves the stability of the movement of the first connecting rod 511.

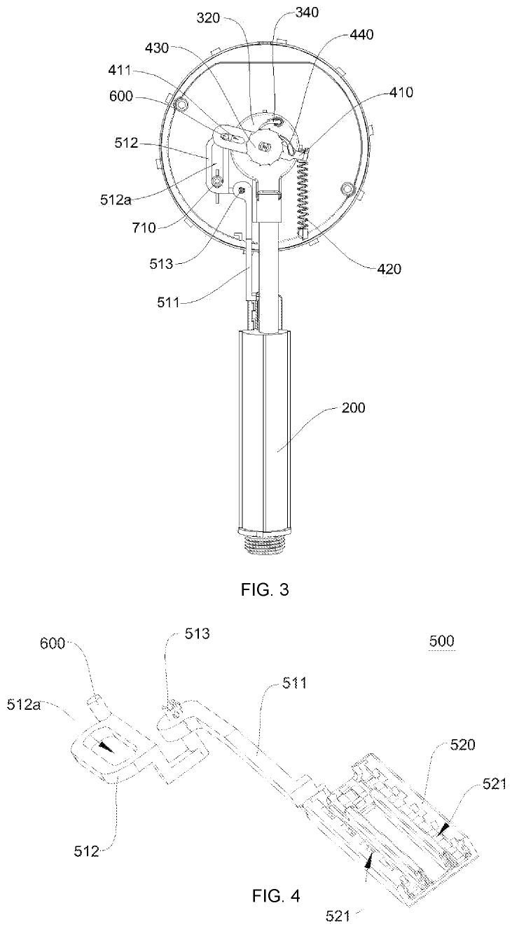

As shown in FIGS. 2 and 3, in some embodiments of the present disclosure, the driving component 410 is rotationally arranged between the rear cover 320 and the ratchet wheel 430, which means that the driving component 410 can rotate relative to the rear cover 320 and the ratchet wheel 430. This ensures that during the reset process of the driving component 410, it is possible to avoid the rear cover 320 and the ratchet wheel 430 from obstructing the drive member 410, thus ensuring the smoothness and stability of the driving component 410 during the reset process.

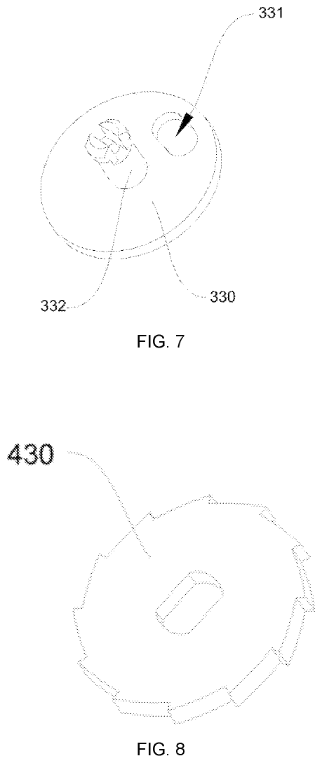

As shown in FIGS. 2, 5, and 7, according to some embodiments of the present disclosure, a side of the rear cover 320 facing the driving component 410 is provided with a flange 321. The driving component 410 is provided with a through-hole 412, and the driving component 410 is rotatably sleeved on the flange 321 through the through-hole 412. In other words, the driving component 410 can rotate around the axis of the flange 321, which means the axis of the through-hole 412 coincides with the axis of the flange 321.

In addition, the peripheral wall of the flange 321 is provided with a protrusion 322. The inner wall of the driving component 410 is provided with a guide groove 413, wherein the guide groove 413 is in communication with the through-hole 412. It is understood that the guide groove 413 is provided in the hole wall of the through-hole 412. The protrusion 322 is embedded in the guide groove 413 to limit the rotation angle of the driving component 410.

It is important to note that the flange 321 is annular in shape, and a pivot of the water distribution plate 330 can pass through an inner ring of the flange 321 to snap with the ratchet wheel 430. The driving component 410 can be sleeved on an outer ring of the flange 321 to be rotatably connected to the flange 321.

It can be understood that by arranging the protrusion 322 and the guide groove 413 corresponding to the protrusion 322, it is possible to effectively limit the rotational angle of the driving component 410. This ensures that the driving component 410 remains in a stable state under the action of the elastic force of the elastic component 420 and the pushing force of the push rod, thus improving the operational stability of the driving component 410.

As shown in FIG. 4, according to some embodiments of the present disclosure, a side of the slide block 520 facing the water inlet connector 200 is provided with a second guide hole 521, and the second guide hole 521 extends along the length direction of the slide block 520.

In addition, a side of the water inlet connector 200 facing the slide block 520 is provided with a slide rail 210, wherein the slide rail 210 extends along a length direction of the water inlet connector 200.

It is noted that the length direction of the water inlet connector 200 is parallel to the length direction of the slide block 520.

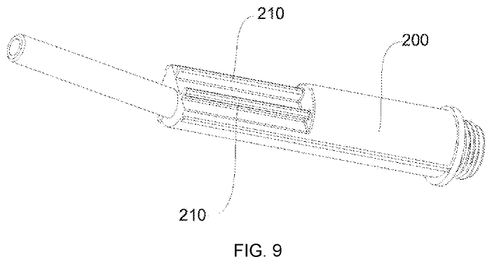

As shown in FIG. 9, in the embodiment, the slide rail 210 is movably arranged in the second guide hole 521 and the slide block 520 is slidably connected to the water inlet connector 200 through the second guide hole 521. It can be understood that the slide rail 210 and the second guide hole 521 limit and guide the slide block 520, thus ensuring the stability and smoothness of the sliding block 520 during the sliding process on the slide rail 210.

As shown in FIGS. 2, 7, and 8, according to some embodiments of the present disclosure, a limiting column 332 is provided on the side of the water distribution plate 330 facing towards the ratchet wheel 430. An axis of the limiting column 332 coincides with an axis of the water distribution plate 330, and the limiting column 332 is perpendicular to the water distribution plate 330.

The limiting column 332 is inserted into the through-hole 412 at the end away from the water distribution plate 330 so as to coaxially connect the ratchet wheel 430 with the water distribution plate 330, thereby achieving coaxial rotation of the water distribution plate 330 and the ratchet wheel 430.

In all examples shown and described herein any specific value should be construed as illustrative only and not as a limitation. Thus, other examples of exemplary embodiments may have different values.

It should be noted that similar numerals and letters denote similar terms in the following drawings so that once an item is defined in one drawing, it does not need to be further discussed in subsequent drawings.

The above-mentioned embodiments only express several implementation modes of the present disclosure, and the descriptions thereof are relatively specific and detailed, but should not be construed as limiting the scope of the present disclosure. It should be pointed out that those skilled in the art may make several modifications and improvements without departing from the concept of the present disclosure, and these all belong to the protection scope of the present disclosure.

### Industrial Practicality

The present disclosure provides a showerhead. The user pulls the switch and then the switch is able to drive the driving component to rotate through the connecting rod. The rotation of the driving component, in turn, drives the water distribution plate to rotate in the forward direction through the ratchet wheel, thus achieving the switching in the position of the water distribution plate. After the external force acting on the switch is withdrawn, the elastic component, under the force of elasticity, pulls the driving component to rotate back so that the driving component, connecting rod, and locking mechanism are enabled to reset. This not only reduces the difficulty of switching the position of the water distribution plate but also enhances the efficiency, continuity, and accuracy of the switching process for the position of the water distribution plate. Additionally, since the ratchet wheel is provided with multiple consecutive ratchet teeth, users can achieve the switching of multiple positions of the water distribution plate with one hand, thereby improving the diversity, efficiency, and convenience of the switching process. The showerhead provided in the present disclosure not only enhances the diversity of water spray modes of the showerhead but also improves the efficiency of adjusting different water spray modes of the showerhead, thereby enhancing the overall experience of the user.

Additionally, it is important to note that the showerhead provided in the embodiments of the present disclosure is reproducible and applicable in various industrial applications. For example, the embodiments of the present disclosure provide a showerhead that can be used in a technology field of showerheads.

What is claimed is:

1. A showerhead, comprising
a casing, comprising a handle part and a mounting part that are connected to each other;
a water inlet connector, mounted inside the handle part;
a water outlet assembly, mounted on the mounting part and comprising a water outlet body, a rear cover, and a water distribution plate, wherein the water outlet body is provided with multiple independent flowing water channels, and the water distribution plate is rotatably arranged on the water outlet body;
a switching assembly, arranged inside the casing and comprising a driving component, an elastic component, and a ratchet wheel, wherein
the ratchet wheel is connected to the water distribution plate, and the driving component is rotatably connected to the rear cover and is configured to drive the ratchet wheel to drive the water distribution plate to rotate; the driving component is provided with a first ratchet tooth engaged with the ratchet wheel; one end of the elastic component is connected to the driving component; and the other end of the elastic component is connected to the water outlet body, and is configured to pull the driving component to reset via the elastic component; and
an actuating component, comprising a connecting rod, a slide block, and a switch, wherein
the switch is connected to the slide block, and the slide block is slidingly connected to the water inlet connector; one end of the connecting rod is connected to the slide block, and the other end of the connecting rod is hinged to the driving component, and is configured to drive the driving component to rotate through the connecting rod;
the switch is able to, under an action of an external force, actuate the slide block to drive the connecting rod to move in a forward direction; the connecting rod drives the driving component to rotate at a preset angle and, through the first ratchet tooth, drives the ratchet wheel, along with the water distribution plate, to rotate at a preset angle; and
when the external force applied to the switch is removed, the elastic component pulls the driving component to rotate back and drives the connecting rod to move in a reverse direction; by arranging a second ratchet tooth on the rear cover to abut against the ratchet wheel, positions of the ratchet wheel and the water distribution plate are limited; and the connecting rod drives the slide block and the switch to reset, thus achieving a switching of a function of water spray.

2. The showerhead according to claim 1, wherein one end of the rear cover facing towards the handle part is in communication with the water inlet connector, and one end of the rear cover facing towards the water outlet body is in communication with the water outlet body through the water distribution plate; and
the second ratchet tooth is arranged on a side of the rear cover facing toward the ratchet wheel, and the second ratchet tooth engages with the ratchet wheel to restrict a reverse rotation of the ratchet wheel.

3. The showerhead according to claim 1, wherein one end of the connecting rod close to the ratchet tooth is provided with a connecting part, and the connecting part is movably connected to the driving component.

4. The showerhead according to claim 3, wherein one side of the handle part is provided with a strip-shaped hole, and the strip-shaped hole is arranged along a length direction of the casing;
a part of the switch is exposed in the strip-shaped hole; and
the switch is slidably connected to the strip-shaped hole; one part of the switch is located on outside of the handle part, and another part of the switch is located inside the handle part and connected to the slide block.

5. The showerhead according to claim 4, wherein the connecting rod comprises a first connecting rod and a first guide rod;
the connecting part is arranged at an end of the first guide rod near the driving component; an end of the first guide rod away from the driving component is provided with a second cylindrical body; and
one end of the first connecting rod is connected to the slide block, and the other end of the first connecting rod is connected to the second cylindrical body.

6. The showerhead according to claim 5, wherein along a length direction of the first guide rod, the first guide rod is provided with a limit hole; and
a side of the water outlet body facing the driving component is provided with a limiting base; the limiting base is provided with a boss, wherein the boss passes through the limit hole to limit and guide the first guide rod through the boss.

7. The showerhead according to claim 1, wherein the driving component is rotationally provided between the rear cover and the ratchet wheel.

8. The showerhead according to claim 1, wherein a side of the rear cover facing the driving component is provided with a flange; the driving component is provided with a through-hole, and the driving component is rotatably sleeved on the flange through the through-hole; and
a peripheral wall of the flange is provided with a protrusion; the driving component is provided with a guide groove, wherein the guide groove is in communication with the through-hole; and the protrusion is embedded in the guide groove to limit a rotation angle of the driving component.

9. The showerhead according to claim 8, wherein an inner wall of the through-hole fits against an outer wall of the flange and an axis of the flange coincides with an axis of the through-hole.

10. The showerhead according to claim 8, wherein the flange is annular in shape, and a pivot of the water distribution plate can pass through an inner ring of the flange to snap with the ratchet wheel.

11. The showerhead according to claim 1, wherein a side of the slide block facing the water inlet connector is provided with a second guide hole and a side of the water inlet connector facing the slide block is provided with a slide rail;
the slide rail is movably arranged in the second guide hole, and
the slide block is slidably connected to the water inlet connector through the second guide hole.

12. The showerhead according to claim 11, wherein the side of the water inlet connector facing the slide block is provided with the slide rail, wherein the slide rail extends along a length direction of the water inlet connector.

13. The showerhead according to claim 11, wherein the switch is capable of, under an action of an external force, driving the slide block to slide in the forward direction along a length direction of the water inlet connector and driving, by the slide block, the connecting rod to move in the forward direction.

14. The showerhead according to claim 1, wherein a limiting column is provided on a side of the water distribution plate facing towards the ratchet wheel; and an axis of the limiting column coincides with an axis of the water distribution plate, and the limiting column is perpendicular to the water distribution plate.

15. The showerhead according to claim 1, wherein one end of the water distribution plate passes through the rear cover and the driving component, and the water distribution plate is connected to the ratchet wheel.

16. The showerhead according to claim 1, wherein the preset angle is a positive integer multiple of a central angle corresponding to one ratchet tooth of the ratchet wheel.

17. The showerhead according to claim 2, wherein a side of the slide block facing the water inlet connector is provided with a second guide hole and a side of the water inlet connector facing the slide block is provided with a slide rail;
the slide rail is movably arranged in the second guide hole, and
the slide block is slidably connected to the water inlet connector through the second guide hole.

18. The showerhead according to claim 3, wherein a side of the slide block facing the water inlet connector is provided with a second guide hole and a side of the water inlet connector facing the slide block is provided with a slide rail;
the slide rail is movably arranged in the second guide hole, and
the slide block is slidably connected to the water inlet connector through the second guide hole.

19. The showerhead according to claim 4, wherein a side of the slide block facing the water inlet connector is provided with a second guide hole and a side of the water inlet connector facing the slide block is provided with a slide rail;
the slide rail is movably arranged in the second guide hole, and
the slide block is slidably connected to the water inlet connector through the second guide hole.

20. The showerhead according to claim 5, wherein a side of the slide block facing the water inlet connector is provided with a second guide hole and a side of the water inlet connector facing the slide block is provided with a slide rail;
the slide rail is movably arranged in the second guide hole, and
the slide block is slidably connected to the water inlet connector through the second guide hole.
